(19) United States
(12) Patent Application Publication
(10) Pub. No.: US 2018/0229720 A1
(43) Pub. Date: Aug. 16, 2018

(54) METHOD AND MECHANISM THAT ASSISTS A PARKING PROCESS OF A MOTOR VEHICLE

(71) Applicant: FORD GLOBAL TECHNOLOGIES, LLC, Dearborn, MI (US)

(72) Inventors: Ahmed BENMIMOUN, Aachen (DE); Georg NEUGEBAUER, Herzogenrath NRW (DE); Nadja WYSIETZKI, Cologne (DE); Lars KUHNERT, Cologne (DE)

(73) Assignee: FORD GLOBAL TECHNOLOGIES, LLC, Dearborn, MI (US)

(21) Appl. No.: 15/895,334

(22) Filed: Feb. 13, 2018

(30) Foreign Application Priority Data
Feb. 13, 2017 (DE) 102017202259.0

(51) Int. Cl. B60W 30/06; G05D 1/00; G05D 1/02; B60W 50/10; B60W 50/14

(52) U.S. Cl. CPC B60W 30/06; G05D 1/0044; G05D 1/0225; B60W 2550/40; B60W 50/14; B60W 2050/146; B60W 50/10

(57) ABSTRACT

A method and a device assist a parking process of a motor vehicle. A number of different parking options are determined that differ from each other regarding the parking space to be accessed during the parking process. A selection capability for the driver to select one of said parking options is provided. The parking process is initiated on the basis of the selection made by the driver.

### CROSS-REFERENCE TO RELATED APPLICATIONS

This application claims foreign priority benefits under 35 U.S.C. § 119(a)-(d) to DE Application 10 2017 202 259.0 filed Feb. 13, 2017, which is hereby incorporated by reference in its entirety.

### TECHNICAL FIELD

The disclosure concerns a method and a device that assists a parking process of a motor vehicle.

### BACKGROUND

Remote-control parking is a parking function that undertakes steering, shifting, accelerating and braking of the vehicle during performance of a parking maneuver into a parking space or a garage, or when carrying out the corresponding unparking maneuver.

In this case, the driver controls said function by means of an intelligent remote-control device (SRD=“Smart Remote Device”) from a position located outside the vehicle. Such remote-control devices are known for example from DE 103 46 888 A1 and DE 10 2008 051 982 A1.

For further prior art, we refer only by way of example to U.S. Pat. No. 7,012,550 B2, US 2013/0268141 A1, US 2014/0067163 A2 and CN 102874251.

### SUMMARY

It is an object of the present disclosure to provide a method and a device that assists a parking process of a motor vehicle that enables increased flexibility for the driver regarding the choice of the parking space that is accessed during the parking process, and a parking process that is better adapted to the specific environmental conditions.

A method according to the disclosure that assists a parking process of a motor vehicle comprises the following steps: determining a number of different parking options that differ from each other regarding the parking space to be accessed during the parking process; providing a selection capability for the driver for selecting one of said parking options; and initiating the parking process based on a selection made by the driver.

### BRIEF DESCRIPTION OF THE DRAWINGS

FIG. 1 shows a flow chart for describing the possible process of a method according to an embodiment of the disclosure.

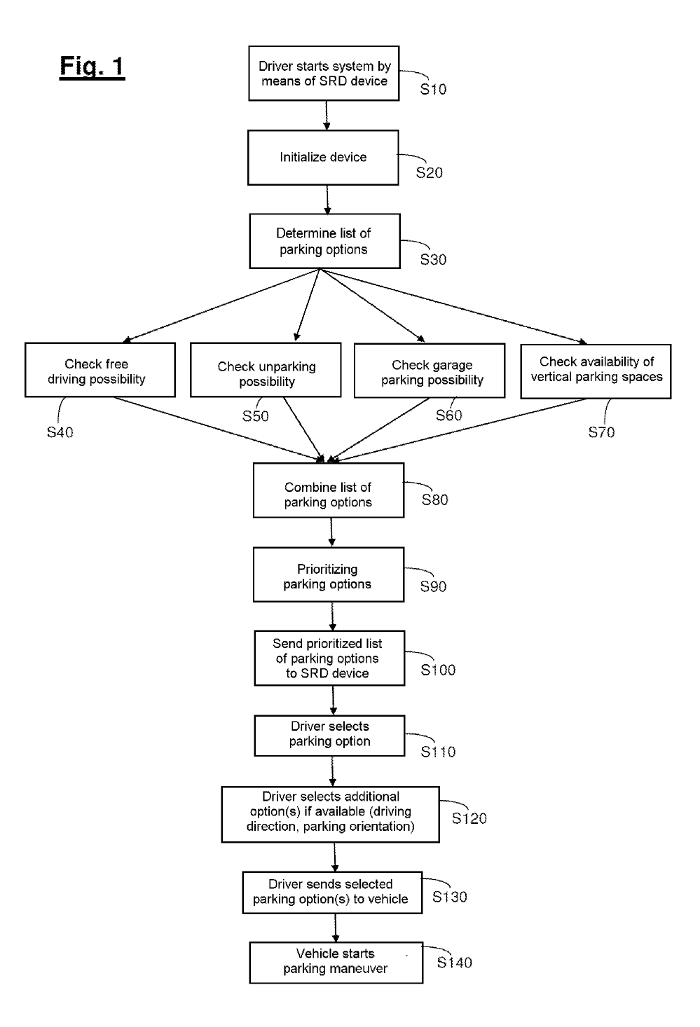

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

A method and a device that assists a parking maneuver are especially provided by the disclosure that enable the driver to select a respective desired parking space among a number of possible parking options. In this case, in particular a number of possible parking options are calculated and listed, wherein the driver can select the desired parking space via an intelligent remote-control device (SRD device).

Following initialization, the system according to the disclosure for remote-control parking calculates a list of possible parking spaces based on surroundings of the vehicle. In embodiments of the disclosure, said list of car parks or parking spaces is then sent to an intelligent remote-control device (SRD device), through which the driver can select the desired parking space.

In an exemplary embodiment, the possible parking options include for example “free driving” (in which the forward or reverse movement of the vehicle without steering is enabled), the existence of a defined unparking capability, garage parking, vertical parking and parallel parking. In this instance, unparking may refer to a process in which the driver activates the vehicle, and shifts the vehicle into a driving state such that the driver may leave the parking space.

In practice, scenarios are possible in which a number of considered parking spaces have been detected, but wherein certain parking spaces correspond to the parking space desired by the driver with a higher probability than others. In embodiments of the disclosure, prioritization of the determined list of possible parking spaces is carried out based on defined features (for example how good a model is that is being used and that describes the surroundings of the respective parking space, or how far the relevant parking space is from the current position).

Moreover, the respective user can be given the possibility of selecting certain further options (such as for example “carrying out the parking and/or unparking process while driving forwards”, “carrying out the parking and/or unparking process while reversing”, “unparking to the left”, “unparking to the right”, “unparking straight ahead”).

The intelligent remote-control device (SRD-device) organizes or manages the relevant parking options and displays the list of parking options in a user-friendly way.

The disclosure further concerns a device that assists a parking process of a motor vehicle that is configured to carry out a method with the features described above. For the advantages and advantageous embodiments of the device, refer to the above embodiments in combination with the method according to the disclosure.

Further embodiments of the disclosure can be obtained from the description.

The disclosure is described in detail below using exemplary embodiments with reference to the accompanying Figure.

The single Figure shows a flow chart for describing the possible process of a method according to an embodiment of the disclosure.

In addition, a possible scenario during the operation of the device according to the disclosure is described with reference to the flow chart represented in the Figure.

In a step S10, the driver starts the device, according to the disclosure, for remote-control parking via an intelligent remote-control device (SRD). Following initialization of the device in the step S20, a number of existing parking options is determined in the step S30, and a corresponding list is produced. In the exemplary embodiment, the check for the existence of a possibility for free driving is carried out (i.e. possible forward or reverse driving without the need for steering) in the step S40, the check for an unparking capability in the step S50, the check for an existing parking option in a garage (step S60) and the check for the presence of vertical parking spaces (step S70).

In the step S80, the existing parking options are combined.

Then, in the step S90 a prioritization of the parking options is carried out, whereupon in the step S100 the corresponding prioritized list of parking options is sent to the intelligent remote-control device (SRD) (step S100).

In the step S110, the driver selects one or more parking options. Furthermore, in the step S120 the driver can select one or more additional options, if available, such as for example a defined driving direction during a parking or unparking process, a defined parking orientation of the vehicle in the parking space, etc.

In the step S130 the intelligent remote-control device (SRD) sends the selected parking option to the vehicle, whereupon the vehicle starts the parking maneuver in the step S140.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method that assists a parking process of a motor vehicle comprising:
determining a number of different parking options that differ from each other regarding a parking space to be accessed during the parking process;
providing a selection capability by listing parking options on a display for a driver to select one of the options;
prioritizing the listing of the parking options in a defined ranking order based on a distance of a parking space corresponding to a respective parking option from a current location of the motor vehicle; and
initiating the parking process based on a selection made by the driver.

2. The method as claimed in claim 1, wherein the display is a remote-control device carried by the driver.

3. The method as claimed in claim 1, wherein prioritizing the listing of parking options is also based on a quality of a model that describes surroundings of the parking space corresponding to the respective parking option.

4. The method as claimed in claim 1 further comprising selecting at least one additional option indicating a defined driving direction during the parking process or the unparking process for the respective parking option.

5. The method as claimed in claim 4, wherein said additional option also includes selection from: carrying out the parking or an unparking process while driving forwards, carrying out the parking or the unparking process while reversing, unparking to a left, unparking to a right, and unparking straight ahead.

6. A park assist system comprising:
a device configured to, in response to a selection on a display of a parking option from a list of parking options indicating different accessible spaces, the list being prioritized in a defined ranking order based on a distance of a space corresponding to a respective parking option from a current location of a vehicle, initiate the parking process based on the selection.

7. The park assist system as claimed in claim 6, wherein the display is included on a remote-control device carried by a driver.

8. The park assist system as claimed in claim 6, wherein the list is further prioritized based on a quality of a model that describes surroundings of the accessible spaces corresponding to the respective parking option.

9. The park assist system as claimed in claim 6, wherein the respective parking option includes an additional optional being a defined driving direction during the parking process or an unparking process.

10. The park assist system as claimed in claim 9, wherein the defined driving direction includes one or more of: driving forwards, reversing, unparking to a left, unparking to a right, or unparking straight ahead.

11. A park assist device for a vehicle comprising:
in response to a selection on a display of a parking option from a list of parking options indicating different accessible spaces, the list being prioritized in a defined ranking order based on a distance of the parking space corresponding to the respective parking option from a current location of a vehicle, initiate the parking process based on the selection.

12. The park assist device for a vehicle as claimed in claim 11, wherein the display is a remote-control device carried by the driver.

13. The park assist device for a vehicle as claimed in claim 11, wherein the list is further prioritized based on a quality of a model that describes surroundings of the accessible spaces corresponding to the respective parking option.

14. The park assist device for a vehicle as claimed in claim 11, wherein the respective parking option includes an additional optional being a defined driving direction during the parking process or an unparking process.

15. The park assist device for a vehicle as claimed in claim 14, wherein the defined driving direction includes one or more of: driving forwards, reversing, unparking to the left, unparking to the right, or unparking straight ahead.
